(19) United States
(12) Patent Application Publication
(10) Pub. No.: US 2020/0265310 A1
(43) Pub. Date: Aug. 20, 2020

(54) NAVIGATION AND ANALYSIS ENGINE FOR AGGREGATE AND INDIVIDUAL INDICATORS

(71) Applicant: Profit Focus LLC, Fremont, CA (US)

(72) Inventor: Bastin S. Gerald, Fremont, CA (US)

(73) Assignee: Profit Focus LLC, Fremont, CA (US)

(21) Appl. No.: 16/793,217

(22) Filed: Feb. 18, 2020

Related U.S. Application Data
(60) Provisional application No. 62/806,289, filed on Feb. 15, 2019.

(51) Int. Cl. G06N 3/08; G06F 16/9035; G06F 9/54

(52) U.S. Cl. CPC G06N 3/08; G06F 9/542; G06F 16/9035

(57) ABSTRACT

A method of processing events and aggregating translated actions for a plurality of processes includes receiving input from a first user at a first user interface defining an executed process that is monitored by the computer system during execution; automatically generating a first event based on receiving the input; translating the first event into one or more actions for one or more users; aggregating a plurality of actions for a second user in the one or more users including at least one of the actions translated from the first event and additional actions translated from events from other user interfaces other than the first user interface; and causing the plurality of actions for the second user to be displayed in a unified action list including actions from different sources.

### CROSS-REFERENCES TO RELATED APPLICATIONS

This application claims the benefit of U.S. Provisional Application No. 62/806,289, filed on Feb. 15, 2019, entitled NAVIGATION AND ANALYSIS ENGINE FOR AGGREGATE AND INDIVIDUAL INDICATORS, which is incorporated herein by reference.

### BACKGROUND

Process monitoring in a computerized environment may include many different types of processes that are executed in parallel. These executed processes may be submitted by a plurality of different users, each of which may generate processes, monitor processes, and/or update existing processes. However, one process may be linked to a plurality of different users beyond the original user who defined the process and submitted it for execution. Each of these users may need access to a current execution state of the process, therefore improvements are needed in the art.

### BRIEF SUMMARY

In some embodiments, a method of processing events and aggregating translated actions for a plurality of processes may include receiving input from a first user at a first user interface in a plurality of user interfaces, where the input may define an executed process that is monitored by the computer system during execution. The method may also include automatically generating a first event based on receiving the input through the first user interface, and translating the first event into one or more actions for one or more users. The method may additionally include aggregating a plurality of actions for a second user in the one or more users, where the plurality of actions may include at least one of the one or more actions translated from the first event and a plurality of additional actions translated from events that were automatically generated based on receiving inputs through other user interfaces in the plurality of user interfaces other than the first user interface. The method may further include causing the plurality of actions for the second user to be displayed in a unified action list comprising actions from a plurality of different sources.

In some embodiments, a non-transitory computer-readable medium may include instructions that, when executed by one or more processors, cause the one or more processors to perform operations including receiving input from a first user at a first user interface in a plurality of user interfaces, where the input may define an executed process that is monitored by the computer system during execution. The operations may also include automatically generating a first event based on receiving the input through the first user interface, and translating the first event into one or more actions for one or more users. The operations may additionally include aggregating a plurality of actions for a second user in the one or more users, where the plurality of actions may include at least one of the one or more actions translated from the first event and a plurality of additional actions translated from events that were automatically generated based on receiving inputs through other user interfaces in the plurality of user interfaces other than the first user interface. The operations may further include causing the plurality of actions for the second user to be displayed in a unified action list comprising actions from a plurality of different sources.

In some embodiments, a system may include one or more processors and one or more memory devices include instructions that, when executed by the one or more processors, causes the one or more processors to perform operations including receiving input from a first user at a first user interface in a plurality of user interfaces, where the input may define an executed process that is monitored by the computer system during execution. The operations may also include automatically generating a first event based on receiving the input through the first user interface, and translating the first event into one or more actions for one or more users. The operations may additionally include aggregating a plurality of actions for a second user in the one or more users, where the plurality of actions may include at least one of the one or more actions translated from the first event and a plurality of additional actions translated from events that were automatically generated based on receiving inputs through other user interfaces in the plurality of user interfaces other than the first user interface. The operations may further include causing the plurality of actions for the second user to be displayed in a unified action list comprising actions from a plurality of different sources.

In any embodiments, any or all of the following features may be implemented in any combination and without limitation. The method/operations may also include determining a type of the first event based on a type of the first user interface in the plurality of user interfaces. Translating the first event into one or more actions for one or more users may include identifying the second user as being associated with the executed process; extracting one or more fields from the event; and generating a first action using the one or more fields from the event and an identifier for the second user. The method/operations may also include accessing a pre-trained model for the first event and the first user; providing a plurality of fields from the first event to the pre-trained model; receiving an output from the pre-trained model predicting an outcome of the executed process; and causing the output from the pre-trained model predicting the outcome of the executed process to be displayed as part of the unified action list. The plurality of user interfaces may include an interface for defining a new key result for the executed process; an interface for defining a new objective for the executed process; and an interface for creating a reference to the second user in a feed. The interface for defining a new key result for the executed process may include receiving a selection of a key result type from a plurality of different key result types. The method/operations may also include receiving the first event at an event listener that is subscribed to events generated by the first user interface.

### BRIEF DESCRIPTION OF THE DRAWINGS

A further understanding of the nature and advantages of the present invention may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a hardware diagram of a system for managing OKRs, according to some embodiments.

FIG. 2 illustrates an architecture of software layers that can be used to build the OKR management system described herein, according to some embodiments.

FIG. 3 illustrates a data model, according to some embodiments.

FIG. 4A illustrates a user interface that displays a unified action list for user from a plurality of different sources, according to some embodiments.

FIG. 4B illustrates a review window that may be generated as part of a user interface, according to some embodiments.

FIG. 4C illustrates how an action can be approved/rejected to be removed from the unified action list, according to some embodiments.

FIG. 5A illustrates an example of a user interface for executing a check-in action, according to some embodiments.

FIG. 5B illustrates an example of a review window for a check-in action, according to some embodiments.

FIG. 6 illustrates a filter for selecting different types of actions, according to some embodiments.

FIG. 7 illustrates a user interface that includes a review window for reviewing new/existing key results, according to some embodiments.

FIG. 8 illustrates a simplified action-event diagram for translating input from various user interfaces into actions for users, according to some embodiments.

FIG. 9 illustrates an alternate architecture that includes an action translation process.

FIG. 10 illustrates flowchart for determining a type of key result that may be generated based on inputs provided by the user through the user interface, according to some embodiments.

FIG. 11 illustrates a flowchart of a method for processing events and aggregating translated actions for a plurality of processes, according to some embodiments.

FIG. 12 illustrates an exemplary computer system, in which various embodiments may be implemented.

### DETAILED DESCRIPTION

Described herein, are embodiments for efficiently processing events and aggregating translated actions for a plurality of processes. In some embodiments, operations may include receiving input from a first user at a first user interface defining an executed process that is monitored by the computer system during execution; automatically generating a first event based on receiving the input; translating the first event into one or more actions for one or more users; aggregating a plurality of actions for a second user in the one or more users including at least one of the actions translated from the first event and additional actions translated from events from other user interfaces other than the first user interface; and causing the plurality of actions for the second user to be displayed in a unified action list including actions from different sources.

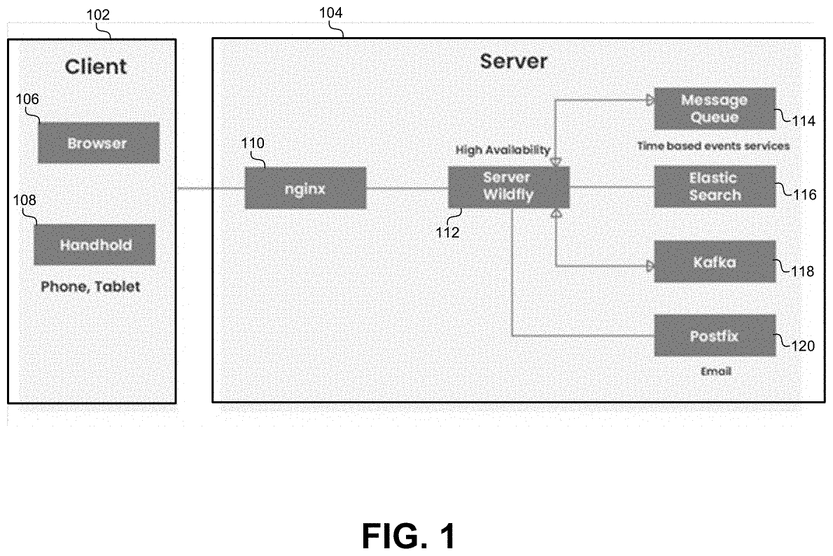

FIG. 1 illustrates a hardware diagram of a system for managing processes, according to some embodiments. The system may include a server 104 that receives requests from one or more client devices 102. The client devices 102 may include computing devices with operating systems using a web browser 106, such as a laptop computer, a desktop computer, a tablet computer, a workstation, and so forth. The client devices 102 may also include handheld devices 108, such as smart phones, smart watches, PDAs, tablets, and so forth, that may use a dedicated application (“app”) and/or a browser 106. The client devices 102 may log into the server 104 and display the user interfaces generated by the server 104 on a local display device, such as a touchscreen or flatscreen display. Through these user interfaces, the users can manage and navigate the OKR information as described in detail below.

The server 104 may include a load balancer 110 configured to receive a large number of requests from the plurality of client devices 102 and manage the bandwidth to provide low-latency, high-availability responses. For example, an NGINX® Platform as a service (PaaS) may provide load-balancing operations, microservice management, cloud deployment, information security, an API Gateway, deployment of mobile and web applications, and other services on which the system described below may be implemented and distributed to the client devices 102. An application runtime, such as the WildFly® application server 112 that runs Java applications can provide a high-availability application deployment. The server 104 may also include a message queue 114, a search service 116, a distributed streaming platform 118, a mail server 120, and/or other server components that are not explicitly shown in FIG. 1.

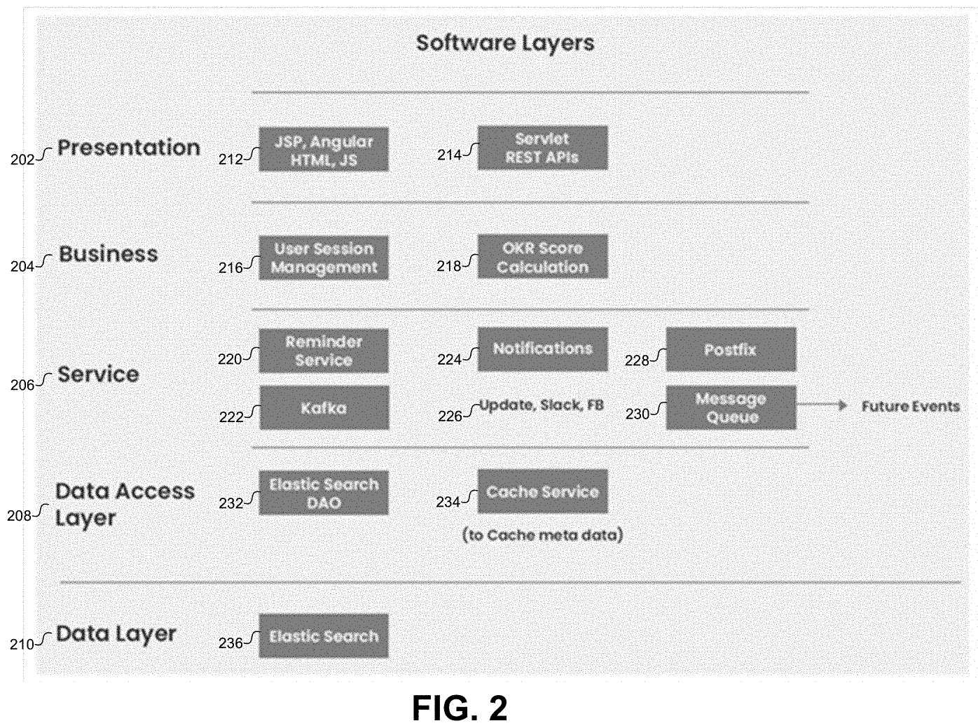

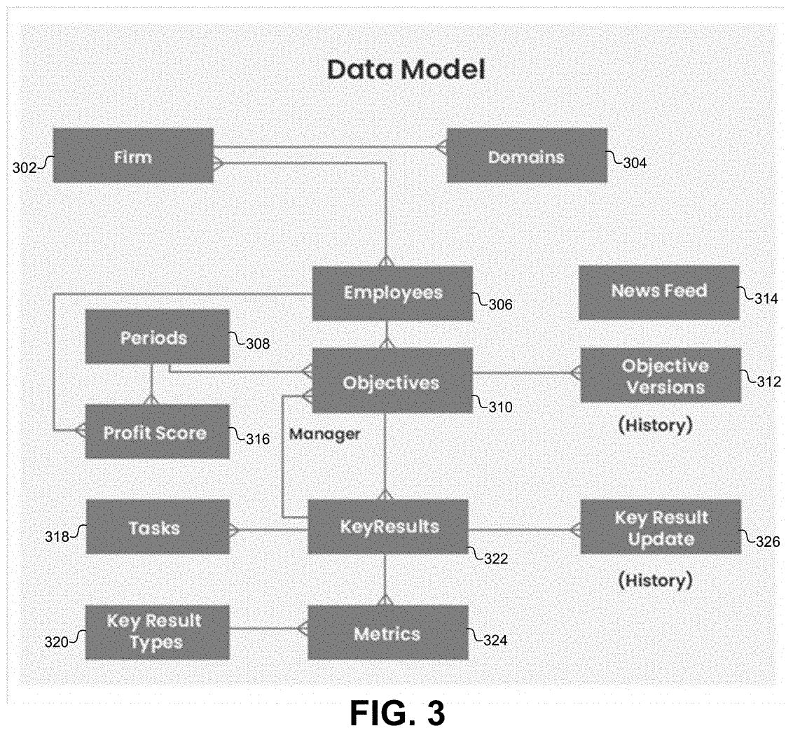

FIG. 2 illustrates an architecture of software layers that can be used to build the process management system described herein, according to some embodiments. The architecture may include a presentation layer 202 that defines JavaServer Pages, JavaScript, HTML, and HTML extensions, such as AngularJS 212. The presentation layer 200 may provide various APIs, such as the REST API and small servlets to provide responses to user inputs 214. The architecture may also include a business layer that manages user sessions 216 and performs high-level calculations 218 on the underlying OKR data values stored in the data model described below in FIG. 3. A service layer 206 can implement a reminder service 220, a notification service 224, an email server 228, message queues 230, data streaming 222, and/or integrations with third-party platforms, such as Slack®, Facebook®, and so forth. A data access layer 208 can implement the search service and/or data access objects (DAOs) to provide an interface 232 to the process data. The data access layer 208 can also implement a cache service 234 to cache session data and/or metadata. Finally, a data layer 208 can implement the search and/or object access from the data access layer 208 using the low-level access routines.

FIG. 3 illustrates a data model, according to some embodiments. This data model uniquely ties together information for processes in a way that allows the user interface to display and summarize process information in a flexible way for individuals and groups. This data model is specifically designed to efficiently and flexibly represent the process framework to provide the information to the user interfaces described below. The data model may include a field for representing a firm or business 302. Each firm or business 302 may be associated with multiple domains 304. For example, company ABC may be associated with the domains abc.com and abc.co.uk. A business 302 may have a plurality of employees 306, each of which may have an independent data record linked to the data model of FIG. 3. Each business 302 can track its performance through multiple reporting periods 308. As described in greater detail below, each employee or group of employees can receive a calculated score 316 that is tracked over a number of reporting periods 308 to provide a historical and real-time perspective on the process performance of the business 302.

The core data objects of the system include the objectives 310 and key result 322 objects. An objective version object 312 provides a historical view of how each objective 310 changes over time. This data model allows a single objective 310 to be associated with one or more different key results. The key results 322 may have a number of different pre-defined types 320. The key results 322 may also be associated with individual tasks 318, metrics 324, milestone sequences, check frequencies, etc. Through the association of a metric 324 with each key result 322, this system can provide a unique result-by-metric perspective in the user interface described below that can help companies focus on measuring and monitoring the metrics that matter the most. Similar to the objective versions 312 for the objectives 310, the key result update 326 is used to record the historical updates to a key result 322. Individual and group updates to the key result 322 may trigger a recalculation of the score 316 during runtime.

As one example environment, some embodiments may use a system for managing OKRs in a unified software interface. A user interface may include a canvas or dashboard that allows a user to navigate the various aspects of OKR management. The canvas allows users to define objectives, set target dates, define visibility protocols, and navigate objectives both individually and for each management level of an organizational hierarchy. The canvas also allows users to navigate and monitor key results and provides controls for increasing, maintaining, and/or decreasing value metrics associated with objectives. Users may also establish baselines and change measurable key results in any aspect. Some embodiments also provide a metric-centric view of OKRs that are tied to a novel underlying data model that defines how the software stores and manages OKRs for individuals in a way that can also be analyzed from a group perspective. Some embodiments may also provide a watchlist for selectable OKRs that are of interest. Additionally, some embodiments may allow users to individually update their progress on various OKRs. Users can then define filter rules that display OKR updates that match predefined filter criteria. Finally, some embodiments may allow users to create rules that can be used to generate an OKR score. The score can be calculated on both an individual and group basis to provide a rapid overview of OKR performance.

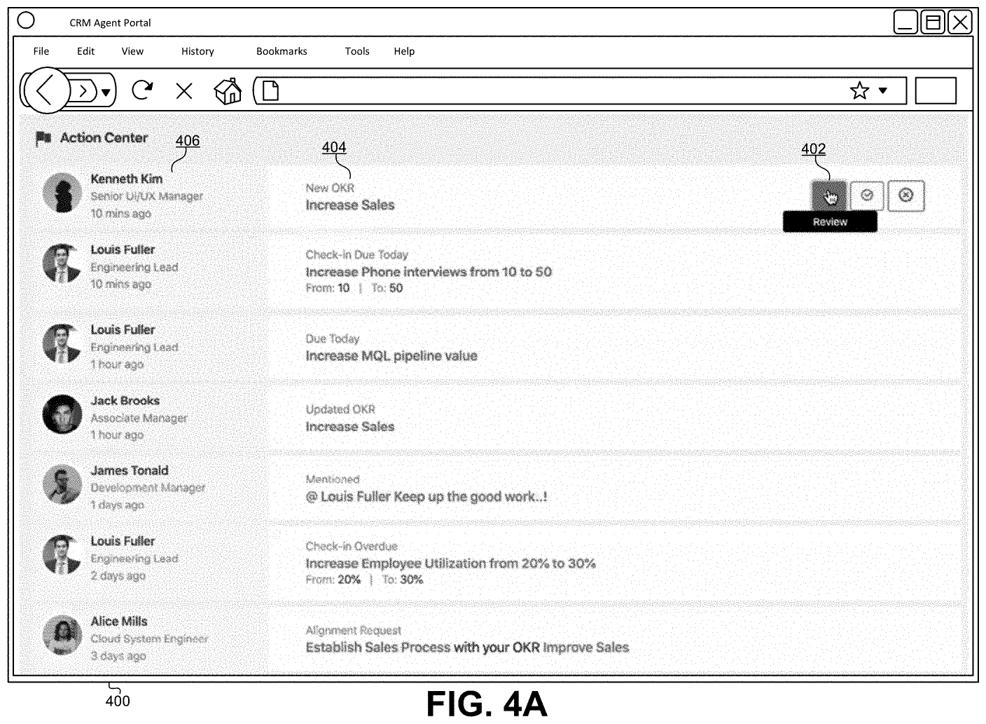

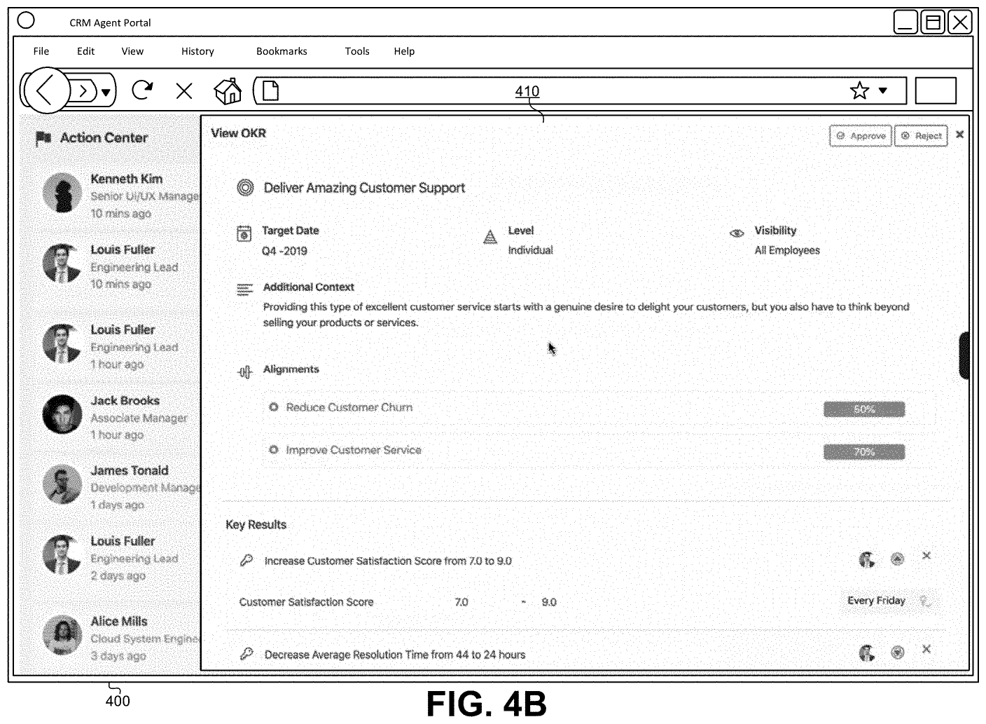

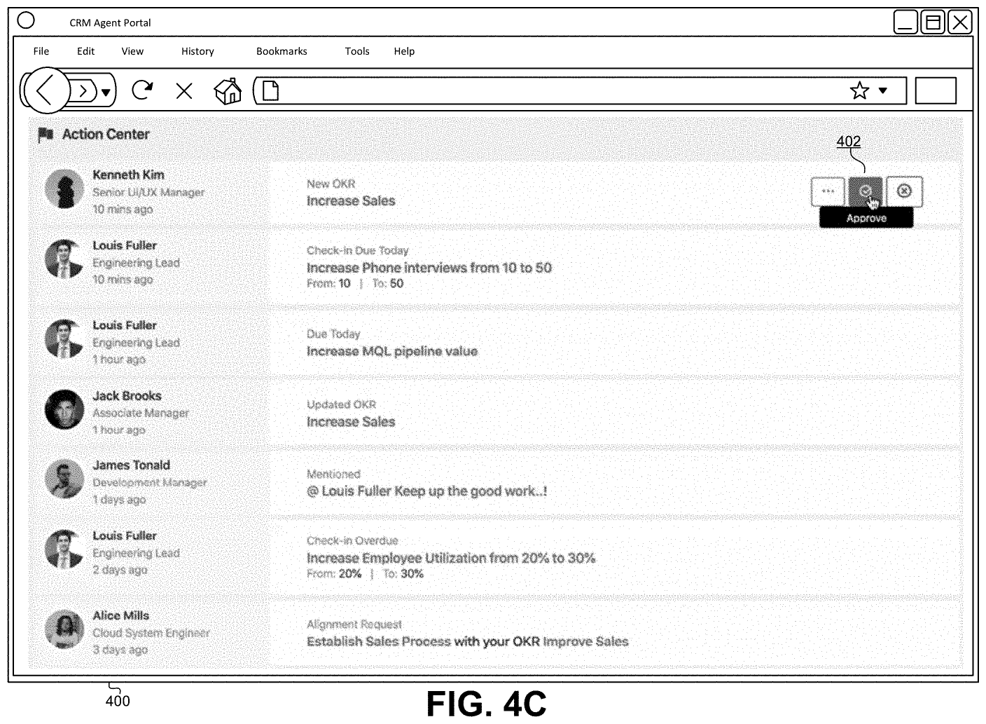

FIG. 4A illustrates a user interface 400 that displays a unified action list for user from a plurality of different sources, according to some embodiments. The user interface 400 may include a unified list of actions that relate to a particular user. As used herein, this user to which the actions apply may be referred to as a “second user” to distinguish the user to which the action is directed from “first users” that may have submitted process definitions or other inputs that generated events that were translated into actions according to the process described below. For example, a “first user” may submit a process definition for a process to be executed, and that process definition may be translated into an action that is to be executed by the “second user.” The terms first/second do not imply order or precedence, but rather are used merely to distinguish one user from the other.

In this example, the unified action list includes at least seven actions to which the second user may need to attend. Each action in the unified action list may be displayed on a horizontal line in the user interface as depicted in FIG. 4A. Any type of information that is descriptive of the action may be displayed in the user interface 400. In this example, summary information for the action is displayed in the action list. For example, a first action in the action list includes a “first user” 406 that submitted a process definition. The unified action list may display a user identifier, a user name, a user title, a time at which the process definition was provided as an input to the computer system, and/or any other information that is descriptive of the user and/or the input of the process definition.

Additionally, each action in the unified action list may display a title or description of the action 404. This may include a type of event that was translated into the action (e.g., new process, check-in due today, due date, updated process, etc.). The title or description of the action 404 may also include an end result of the process execution. For example, a new OKR may be submitted as a process, and the end result of this process may be to “increase sales.” In another example, a previous process definition may have been provided by a first user, and that process definition may have been translated into a plurality of actions that are periodically inserted into the unified action list. For example, one process may require periodic “check ins” by the second user as an action to ensure that the process execution is proceeding as expected. In another example, the first user may have made mention of the second user in a new process definition or in a thread related to an existing process. An action may be submitted in the unified action list that prompts the second user to review the process and/or conditions under which the second user was mentioned.

Each action in the unified action list may also include a menu of options 402 that may be executed by the second user. The menu of options may be generated based on a type of action. For example, an action that requires approval by the second user for a new process may include a control to “review” the new process definition, a control to “approve” the new process definition, and/or a control to “reject” the new process definition in the menu of options 402. For example, for the first action in the unified action list that indicates a new process definition has been submitted for approval, the menu of options 402 may include a control to review the submitted process definition.

FIG. 4B illustrates a review window 410 that may be generated as part of a user interface 400, according to some embodiments. This example may continue from the example of FIG. 4A where the unified action list includes a first action requesting approval from the second user for a new process definition submitted by a first user. If the user clicks the “review” option in the menu of options 402, the review window 410 may be generated and displayed as a pane that is overlaid on top of at least a portion of the unified action list. The review window 404 may include any information that may be reviewed by the second user to approve the new process definition. This may include a target execution date, permissions or visibilities for different users, an execution context for the process, alignments with other processes that have previously been submitted and/or approved by the system, any related key results and numerical characterizations of execution towards those key results, and/or any other process definition information.

The information in the review window 410 may be entirely different for each of the actions the unified action list. The information displayed in the review window 410 may relate specifically to an action requesting approval of a new process definition submitted to the system. Other types of actions, such as a check-in action, a due date action, approving an updated process definition, reviewing a mention of the second user, reviewing a process alignment request, and/or the like, may include information in the review window 410 that is specific to that particular action. As described below, the action object passed from an event listener may include fields that are specific to the action type. However, the unified action list may extract summary information from fields that are common across all action types to display in the unified action list of FIG. 4A. When the second user selects the review option from the menu of options 402, the review window 410 may include the common information from the summary of the unified list of actions, along with additional data fields from the action that are applicable specifically to that action type but not to other action types. This allows the user to quickly see all actions in the unified action list and sort/categorize them according to a common set of criteria that are readily and visibly ascertained. At the same time, this allows the second user to examine the information that is specific to a particular action type by summoning the review window 410.

FIG. 4C illustrates how an action can be approved/rejected to be removed from the unified action list, according to some embodiments. As described above, the menu of options 402 for each action may include options that are specific to that action type. Hovering over the first action may generate a menu of options 402 that includes review/approve/reject options for a new process definition. For the second action in the unified action list, the menu of options (not shown) may include options such as review and/or check-in to complete the action since no approval/rejection need be required. The menu of options 402 may be generated dynamically by determining a type for the action, and retrieving a set of predefined menu options for that particular action type. The menu options for that type may be stored in a database, a data table, a lookup table, or accessible through a web service or other network resource.

For the first action in the unified action list, the user may select either the approve or the reject option. In either case, selecting this option from the menu of options 402 may cause the action to be removed from the unified action list. For some actions, the action definition may require that the second user review the details of the action before allowing the user to approve/reject the new process definition. Note that the review window 410 from FIG. 4B may include approve/reject controls that may be used to approve/reject the new process definition from the review window 410. Other actions may allow the second user to approve/reject the action without requiring additional review of the action details in the review window 410.

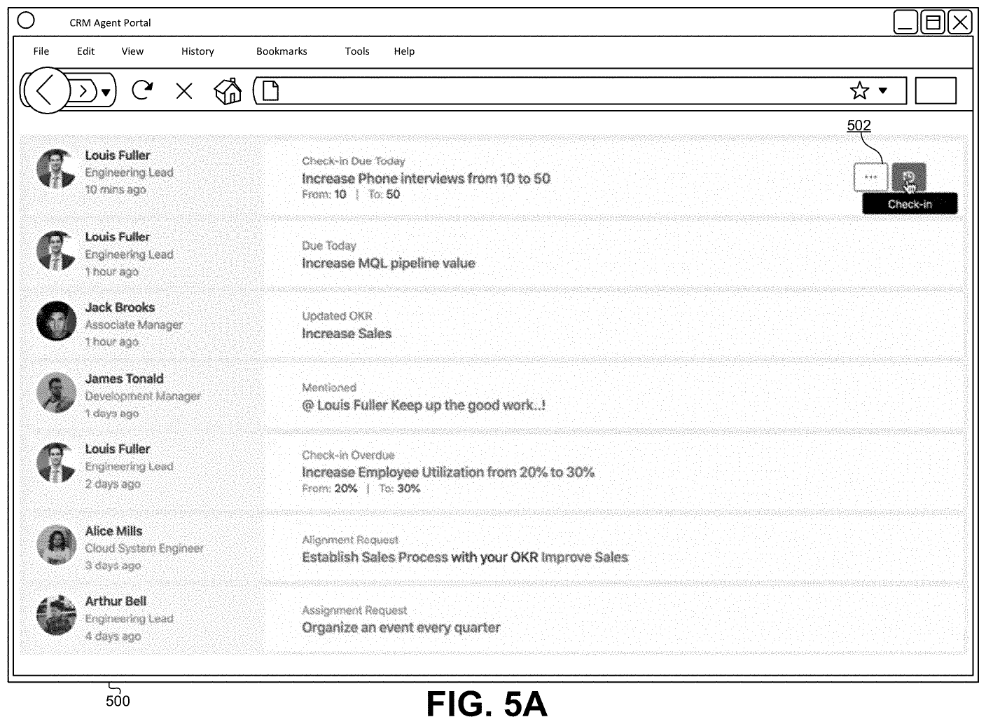

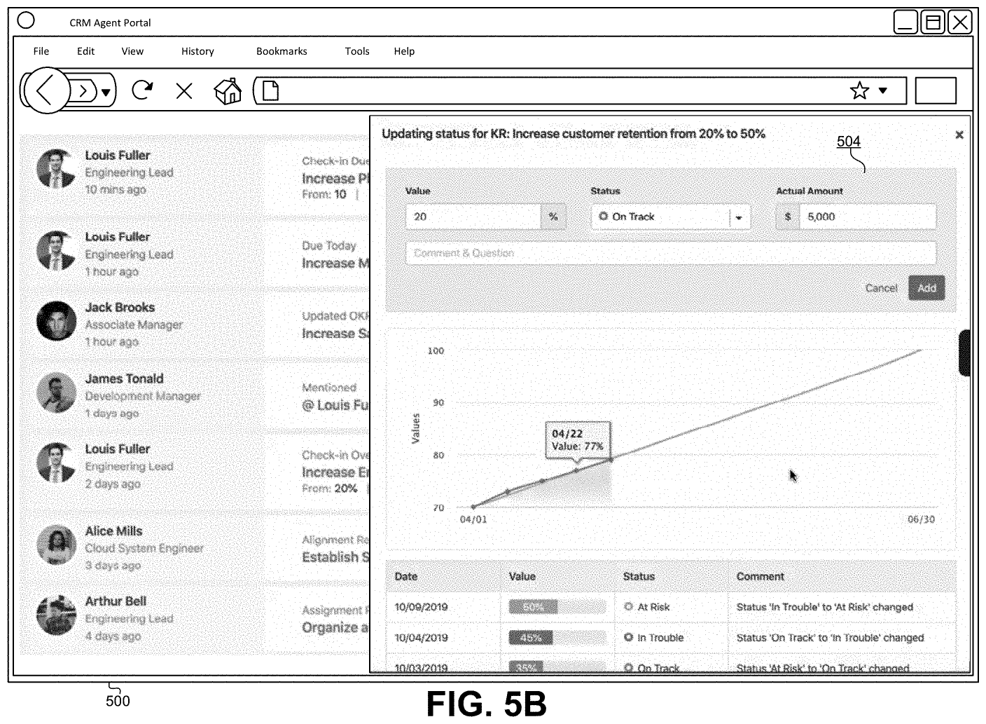

FIG. 5A illustrates an example of a user interface 500 for executing a check-in action, according to some embodiments. As described below, when a new process definition is generated, it may in turn generate an event indicating that a new process was generated. This event object may include any and/or all of the fields that define the new process definition. This event object may then be translated into one or more actions. In this example, the event object may be translated into a plurality of actions that are executed over time. For instance, a new process definition may require the second user to “check-in” on the progress of the process execution on a regular basis. Therefore, the event object may be translated into a plurality of actions, each of which are executed at predefined or regular intervals. As these actions are generated, they may percolate to the top of the unified action list.

In this example, a new process definition may require the second user to check in on the progress on a weekly basis. This event may generate actions with execution dates that are spaced at regular intervals during the duration of the process execution. In FIG. 5A, one of those check-in actions has come due, and requires attention by the second user. The menu of options 502 may be automatically generated based on the type of the action (e.g., the check-in action). Thus, the menu of options 502 may include a review option and/or a check-in option. The check-in option may function similarly to an approval or rejection option described above, in that it may be used to remove the action from the unified action list.

FIG. 5B illustrates an example of a review window 504 for a check-in action, according to some embodiments. As described above, the review window 504 for the checking action includes very different data and/or displays compared to the review window 410 for the new process approval action. Because the process associated with the check-in action may have already been approved, and execution of that process may have already begun, the review window 504 for the checking action may include progress information that indicates process execution state and/or statistics that are descriptive of the process execution progress. For example, a numerical value characterizing the progress of the process execution may be displayed, along with a status indicator that may be assigned from an enumerated list of status indicators that are correlated with the value indicator (e.g., 20% completion may be correlated with an “On Track” status indicator based on the current date).

In some embodiments, a graph of progress showing both past progress and predicted future progress may be illustrated in the review window 504. Additionally, statistics and/or results from previous check-in actions may also be displayed at the bottom of the review window 504. These may include dates at which the check-in actions were executed, values (e.g., percent completions) associated with the process at each of those check-in dates, status indicators, and any comments that were made when the check-in occurred. Note that the review window 504 may also include a text field into which the second user may enter comments associated with the current check-in. These may be provided as a history of comments by the second user that are summarized at the bottom of the review window 504.

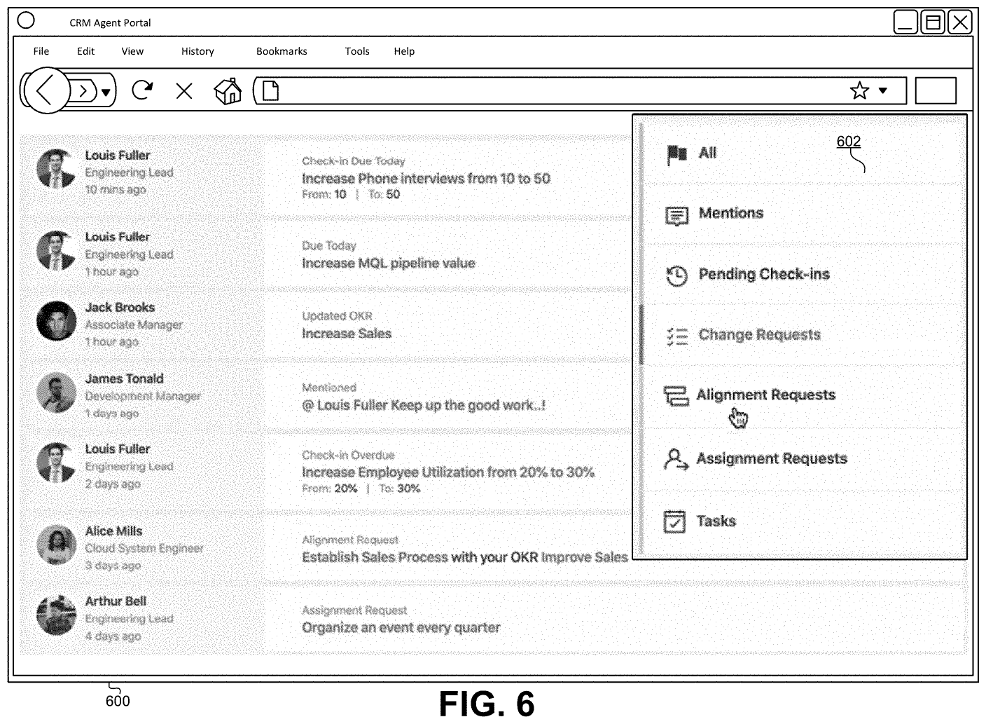

FIG. 6 illustrates a filter 602 for selecting different types of actions, according to some embodiments. As described above, the unified action list may aggregate actions that were generated by a variety of different user interfaces from different data sources. The process that translates events into actions may include generate a number of common fields that may apply to any action, while other fields in the action object may relate only to that specific type of action. One of the advantages of the user interface 600 and other user interfaces described herein is the ability to aggregate different action types from different data sources into a single unified list that is presented in a unified presentation to the second user.

Although the unified list is presented such that each action is formatted and presented in a uniform fashion, some users may wish to filter the unified action list by action type. A filter window 602 may be provided to select different types of actions to be displayed in the user interface 600. As described above, different action types may include mentions that are made of the second user in submitted process definitions and/or other threads, check-ins on process executions that are currently underway, approvals of realignment requests for processes, assignment requests, new process approval/rejections, and/or any other specific task that may be added to the action list. Each of these options may be highlighted in the filter window 602 and used to temporarily remove action types that are not on the filter list and/or highlight action types that are on the filter list.

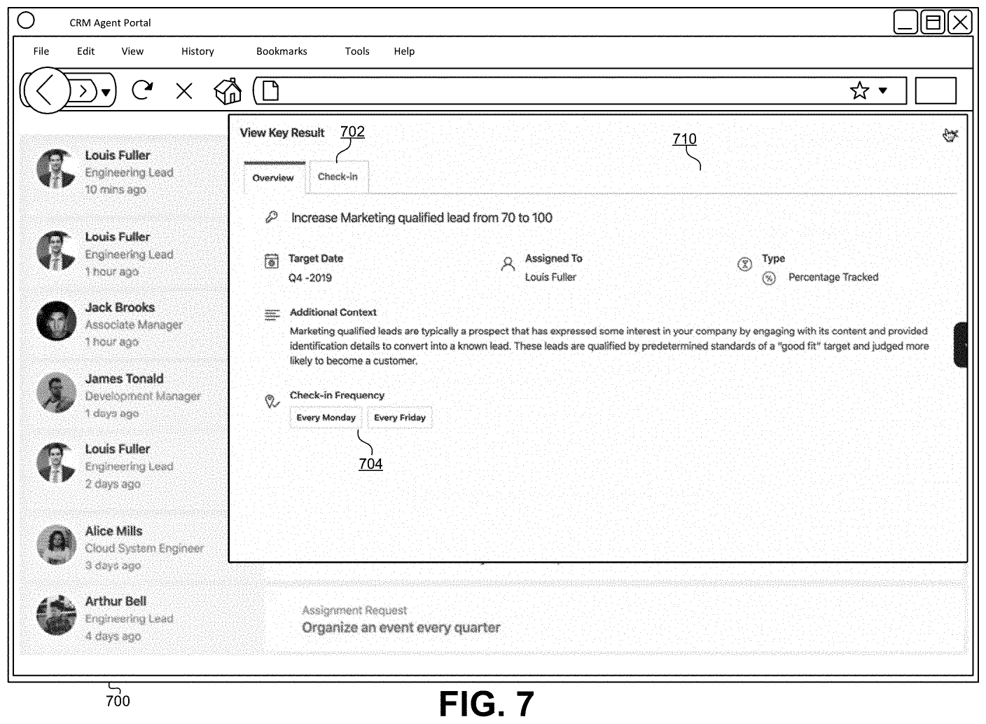

FIG. 7 illustrates a user interface 700 that includes a review window 710 for reviewing new/existing key results, according to some embodiments. In this example, the review window 710 includes tabs 702 for providing an overview of the key result, along with a tab for executing a check-in on the current progress. The tab for executing the check-in may be similar to that described above in FIG. 5B. The tab for the overview of the key result may include information that was provided when the process definition was submitted and/or approved. This may include titles, descriptions, dates, and/or values associated with the overall key result. This may also include a context provided by the second and/or first users when the key result was defined and/or approved.

Notably, this may also include check-in intervals that may be changed and/or defined for the actions related to this event. For example, actions may be automatically generated from the event requiring check-ins on specified days of the week. Review window 710 may include controls 704 that allow the second user to alter the frequency with which these actions populate the unified action list. If the second user uses these controls 704 to change the frequency of the associated check-in actions, check-in actions in the unified action list may be removed, and/or altered accordingly and automatically without additional user input. This may affect the order and timing of when the associated check-in actions appear in the unified action list.

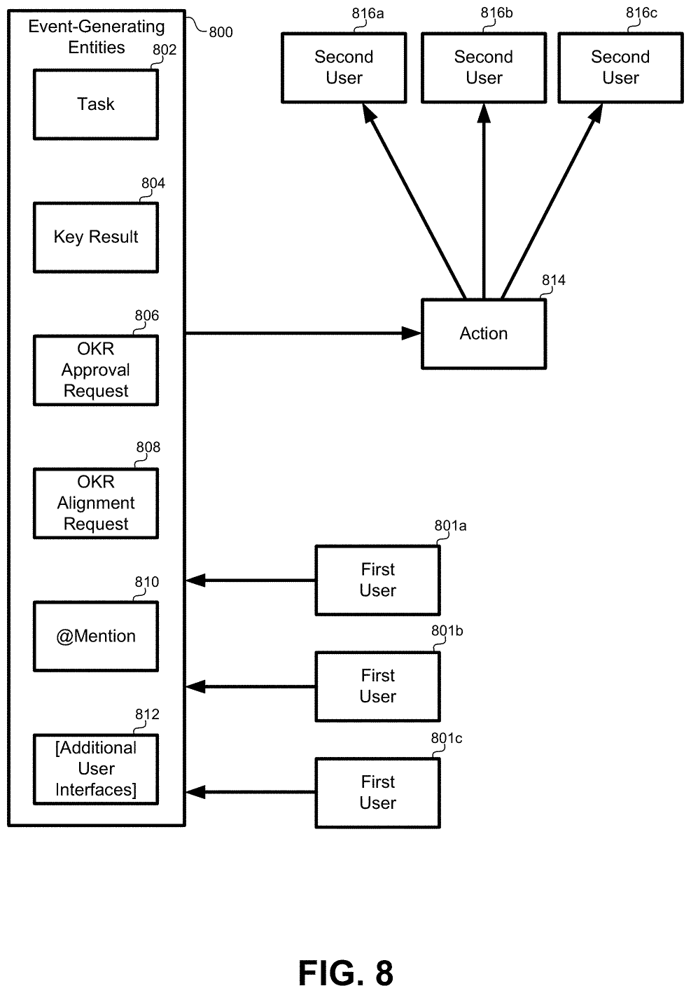

FIG. 8 illustrates a simplified action-event diagram for translating input from various user interfaces into actions for users, according to some embodiments. This simplified diagram illustrates a plurality of event-generating entities 800 that may receive inputs from users and generate events that may be translated into actions. As described above, many of these event-generating entities 800 may include different user interfaces that are associated with different inputs that may be provided to the system. These inputs may be provided by first users 801. As described above, the term “first” users is used to refer to users that generate inputs or process definitions that are later translated into actions, while the term “second” users is used to refer to users that receive actions based on inputs from the “first” users.

The event-generating entities 800 may receive a variety of different inputs through a variety of different interfaces. Examples of these inputs and user interfaces are described in U.S. Provisional Application No. 62/806,289, which is incorporated herein by reference. For example, one user interface may allow users to enter a new process definition defining a new OKR 806. Another user interface may include fields for defining a new key result 804. Some embodiments may include user interfaces or processes that may be used to specifically generate a task 802. The task 802 may be passed as an action through the system directly to one or more of the second users 816. Other types of processes are user interfaces that may receive inputs from the first users 801 may include an interface to realign an existing process 808, an interface that allows a first user 801 to specifically mention a second user 816, and/or additional user interfaces 812 that may exist in a system for processing events and aggregating translated actions for a plurality of process definitions.

When inputs are received from a first user 801 by one or more of the event-generating entities 800, a corresponding event may be generated by the event-generating entities 800. In some embodiments, the input may define an executed process that is monitored by the computer system during its execution. The process may include an incremental progress towards a key result and/or evaluation of a metric, such as an OKR. The input may include fields, values, specific users, metrics, statistics, and/or other values that may define an executed process.

Events generated by the event-generating entities 800 may be translated into one or more actions 814. For example, each event object may include a plurality of fields that define or describe the event definition provided by the input. The user interface may be associated with a type, and the event may also have a type corresponding to the user interface. For example, the user interface for generating a new key result 804 may be associated with a key result type, and the associated event may be a new-key-result event. The event may have a payload that defines various attributes, characteristics, values, and/or descriptions of the new key result definition 104. A process may translate the event object into one or more action objects. For example, as described above, the process may determine the type of the event. After determining that the type is a new-key-result event type, the process may identify one or more second users 816 that are associated with the new key result. The second users 816 may be selected from a user hierarchy, an org chart, and/or any other auxiliary database, data table, lookup table, or data source that associates users with specific processes to be executed. The second users 816 may be designated as recipients of the actions generated from the event.

The one or more actions 814 may be generated based on event type. For example, for the new-key-result event type, the associated one or more actions 814 may include actions that correspond to periodic check-in actions at regular intervals as described in detail above. Additionally, the new-key-result event type may generate and approve/reject actions as described above before the check-in actions are generated. For example, new events may be generated when a second user 816 rejects or authorizes a previous action. Multiple actions may also be generated from a single event. For example, multiple second users 816 may be associated with a single event, and actions may be generated for each of the second users 816. The actions 814 may then be sent to each of the unified action lists for each of the second users 816.

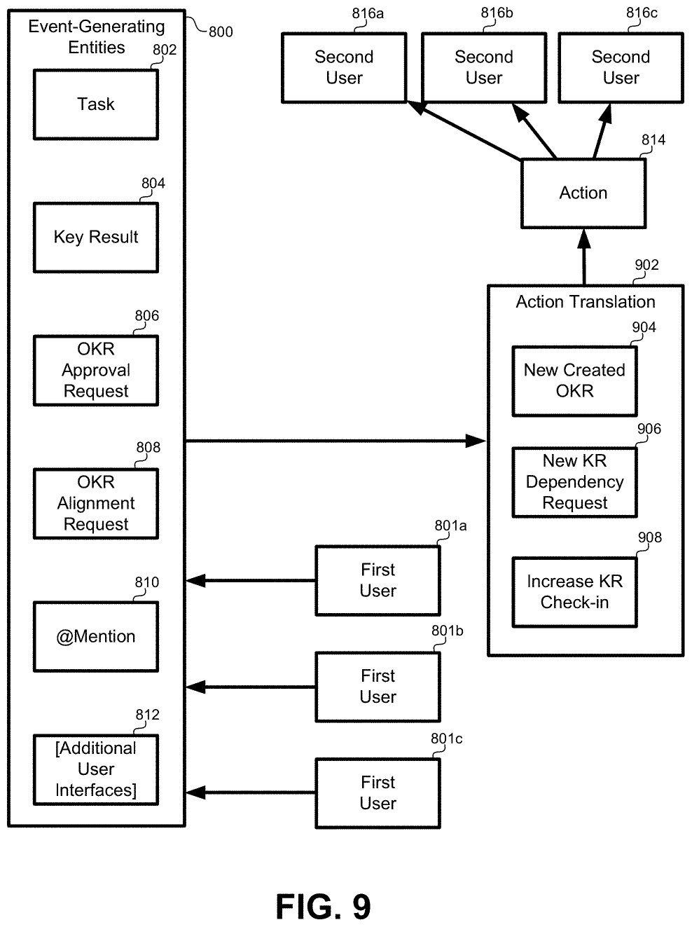

FIG. 9 illustrates an alternate architecture that includes an action translation process 902. The action translation process 902 may include an event listener that subscribes to each of the event-generating entities 800 to receive events as they are generated. Thus, the event-generating entities 800 may receive inputs and generate events that are automatically received by the action translation process 902 and translate them into actions 814 as described above. The action translation process 902 may include entries in a translation table for each event type, including new OKRs 904, new dependency requests 906, increases in check-in rates 908, and so forth. The action translation system 902 may then follow a translation script for each event type to turn the event into one or more actions 814. These action objects may include information from the event objects, and/or additional information that is added by the action translation process 902.

Although not shown explicitly in FIG. 9, some embodiments may also include a machine learning engine and/or a neural network. The neural network may be include a neural network with multiple internal hidden layers. The neural network may be trained using events that are generated for a particular user in previous sessions. The inputs provided to generate the events may be used to train the neural network along with an output of the executed process. For example, the output of the executed process may be a success and/or failure to meet the objective for the process. This may include any delays, or other factors that cause the process to take longer than expected. A model may be trained for each user and for each event type.

When a new event is generated, the system can access the pre-trained model for that event and the corresponding user. The inputs provided may be fed into the model, and the model may generate an output that predicts the success of the current event. This prediction may be provided to the second users 816, and the second users 816 may use this information to approve/reject the new event. For example, the unified action list for a second user 816 may include a prediction, such as a percent likelihood of success, and the entry in the unified action list may include a color coding or other visual indication that indicates a likelihood or status of success based on the output of the model.

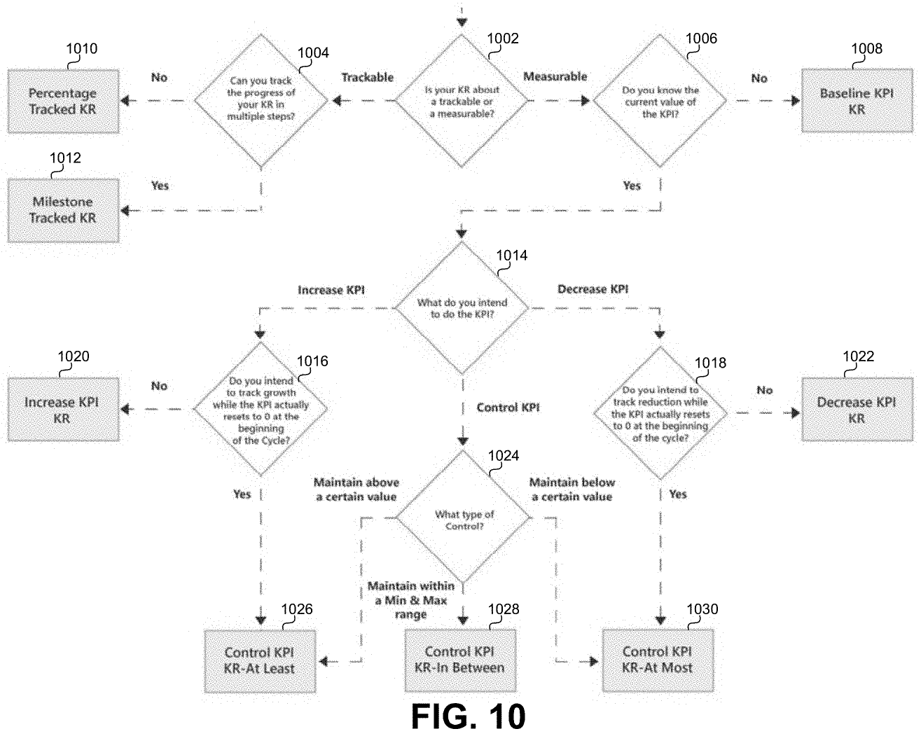

FIG. 10 illustrates flowchart for determining a type of key result that may be generated based on inputs provided by the user through the user interface, according to some embodiments. First, a determination (1002) may be made as to whether the key result is trackable (1004) or measurable (1006). If trackable, then a determination (1004) may be made as to whether the progress can be tracked in multiple steps. If so, then a percentage tracked key result (1010) may be used, and if not then a milestone tracked key result (1012) may be used. If measurable, then a baseline key result may be selected (1008) if a current value of the indicators unknown. If known, a determination (1014) may be made as to whether the current KPI should be increased or decreased. If increased, then a determination (1016) may be made as to whether the KPI resets to zero at the beginning of a cycle. If not, then an increase KPI key result (1020) may be selected, and if so, then a control KPI (1026) may be selected. Additional determinations (1018) may be made for decreasing KPIs (1022, 1030). Finally, a control KPI key results (1028) may be selected for those that fall between a min/max range.

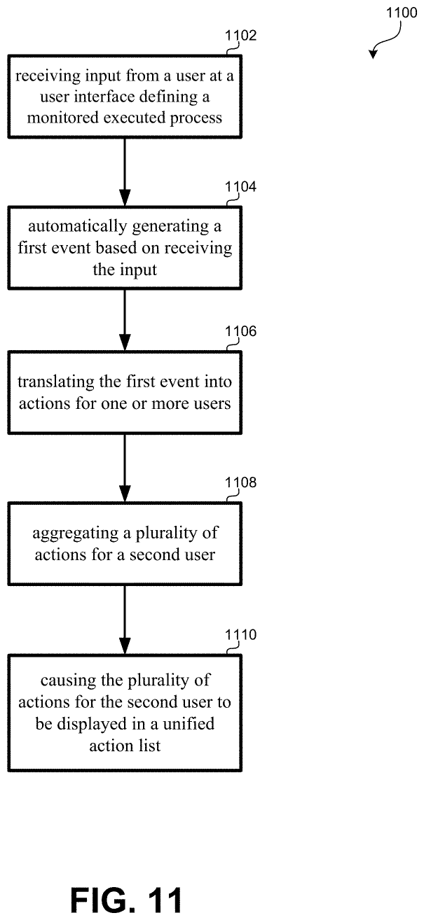

FIG. 11 illustrates a flowchart of a method for processing events and aggregating translated actions for a plurality of processes, according to some embodiments. The method may include receiving input from a first user at a first user interface and a plurality of user interfaces (1102). The input may define an executed process that is monitored by the computer system during execution. The method may also include automatically generating a first event based on receiving the input through the first user interface (1104). The method may additionally include translating the first event into one or more actions for one or more users (1106). The method may further include aggregating a plurality of actions for a second user in the one or more users (1108). The plurality of actions may include a least one of the one or more actions translated from the first event. Additionally, a plurality of additional actions translated from other events that were automatically generated based on receiving inputs to other user interfaces in the plurality of user interfaces may also be included. The method may also include causing the plurality of actions for the second user to be displayed in a unified action list comprising actions from a plurality of different sources (1110). Each of these actions may be carried out as described in detail in the figures and description above.

Each of the methods described herein may be implemented by a computer system. Each step of these methods may be executed automatically by the computer system, and/or may be provided with inputs/outputs involving a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Those steps not involving a user may be said to be performed automatically by the computer system without human intervention. Therefore, it will be understood in light of this disclosure, that each step of each method described herein may be altered to include an input and output to and from a user, or may be done automatically by a computer system without human intervention where any determinations are made by a processor. Furthermore, some embodiments of each of the methods described herein may be implemented as a set of instructions stored on a tangible, non-transitory storage medium to form a tangible software product.

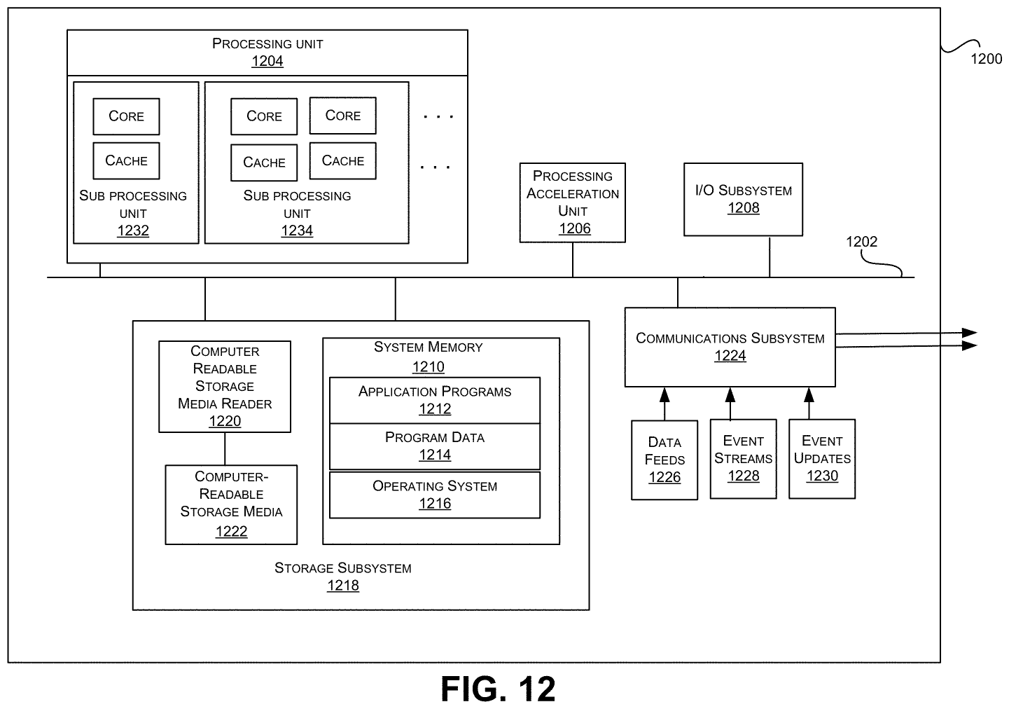

FIG. 12 illustrates an exemplary computer system 1200, in which various embodiments of the present invention may be implemented. The system 1200 may be used to implement any of the computer systems described above. As shown in the figure, computer system 1200 includes a processing unit 1204 that communicates with a number of peripheral subsystems via a bus subsystem 1202. These peripheral subsystems may include a processing acceleration unit 1206, an I/O subsystem 1208, a storage subsystem 1218 and a communications subsystem 1224. Storage subsystem 1218 includes tangible computer-readable storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative embodiments of the bus subsystem may utilize multiple buses. Bus subsystem 1202 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1204, which can be implemented as one or more integrated circuits (e.g., a conventional microprocessor or microcontroller), controls the operation of computer system 1200. One or more processors may be included in processing unit 1204. These processors may include single core or multicore processors. In certain embodiments, processing unit 1204 may be implemented as one or more independent processing units 1232 and/or 1234 with single or multicore processors included in each processing unit. In other embodiments, processing unit 1204 may also be implemented as a quad-core processing unit formed by integrating two dual-core processors into a single chip.

In various embodiments, processing unit 1204 can execute a variety of programs in response to program code and can maintain multiple concurrently executing programs or processes. At any given time, some or all of the program code to be executed can be resident in processor(s) 1204 and/or in storage subsystem 1218. Through suitable programming, processor(s) 1204 can provide various functionalities described above. Computer system 1200 may additionally include a processing acceleration unit 1206, which can include a digital signal processor (DSP), a special-purpose processor, and/or the like.

I/O subsystem 1208 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1200 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1200 may comprise a storage subsystem 1218 that comprises software elements, shown as being currently located within a system memory 1210. System memory 1210 may store program instructions that are loadable and executable on processing unit 1204, as well as data generated during the execution of these programs.

Depending on the configuration and type of computer system 1200, system memory 1210 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1204. In some implementations, system memory 1210 may include multiple different types of memory, such as static random access memory (SRAM) or dynamic random access memory (DRAM). In some implementations, a basic input/output system (BIOS), containing the basic routines that help to transfer information between elements within computer system 1200, such as during start-up, may typically be stored in the ROM. By way of example, and not limitation, system memory 1210 also illustrates application programs 1212, which may include client applications, Web browsers, mid-tier applications, relational database management systems (RDBMS), etc., program data 1214, and an operating system 1216. By way of example, operating system 1216 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 1218 may also provide a tangible computer-readable storage medium for storing the basic programming and data constructs that provide the functionality of some embodiments. Software (programs, code modules, instructions) that when executed by a processor provide the functionality described above may be stored in storage subsystem 1218. These software modules or instructions may be executed by processing unit 1204. Storage subsystem 1218 may also provide a repository for storing data used in accordance with the present invention.

Storage subsystem 1200 may also include a computer-readable storage media reader 1220 that can further be connected to computer-readable storage media 1222. Together and, optionally, in combination with system memory 1210, computer-readable storage media 1222 may comprehensively represent remote, local, fixed, and/or removable storage devices plus storage media for temporarily and/or more permanently containing, storing, transmitting, and retrieving computer-readable information.

Computer-readable storage media 1222 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1200.

By way of example, computer-readable storage media 1222 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1200.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to connect to one or more devices via the Internet. In some embodiments communications subsystem 1224 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1224 can provide wired network connectivity (e.g., Ethernet) in addition to or instead of a wireless interface.

In some embodiments, communications subsystem 1224 may also receive input communication in the form of structured and/or unstructured data feeds 1226, event streams 1228, event updates 1230, and the like on behalf of one or more users who may use computer system 1200.

By way of example, communications subsystem 1224 may be configured to receive data feeds 1226 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1224 may also be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1224 may also be configured to output the structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1200 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

In the foregoing description, for the purposes of explanation, numerous specific details were set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the foregoing description to provide a thorough understanding of the embodiments. However, it will be understood by one of ordinary skill in the art that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have been described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to portable or fixed storage devices, optical storage devices, wireless channels and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In the foregoing specification, aspects of the invention are described with reference to specific embodiments thereof, but those skilled in the art will recognize that the invention is not limited thereto. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Additionally, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A method of processing events and aggregating translated actions for a plurality of processes, the method comprising:
receiving, by a computer system, input from a first user at a first user interface in a plurality of user interfaces, wherein the input defines an executed process that is monitored by the computer system during execution;
automatically generating, by the computer system, a first event based on receiving the input through the first user interface;
translating, by the computer system, the first event into one or more actions for one or more users;
aggregating, by the computer system, a plurality of actions for a second user in the one or more users, wherein the plurality of actions comprises:
at least one of the one or more actions translated from the first event; and
a plurality of additional actions translated from events that were automatically generated based on receiving inputs through other user interfaces in the plurality of user interfaces other than the first user interface; and
causing, by the computer system, the plurality of actions for the second user to be displayed in a unified action list comprising actions from a plurality of different sources.

2. The method of claim 1, further comprising determining a type of the first event based on a type of the first user interface in the plurality of user interfaces.

3. The method of claim 2, wherein translating the first event into one or more actions for one or more users comprises:
identifying the second user as being associated with the executed process;
extracting one or more fields from the event; and
generating a first action using the one or more fields from the event and an identifier for the second user.

4. The method of claim 1, further comprising:
accessing a pre-trained model for the first event and the first user;
providing a plurality of fields from the first event to the pre-trained model;
receiving an output from the pre-trained model predicting an outcome of the executed process; and
causing the output from the pre-trained model predicting the outcome of the executed process to be displayed as part of the unified action list.

5. The method of claim 1, wherein the plurality of user interfaces comprises:
an interface for defining a new key result for the executed process;
an interface for defining a new objective for the executed process; and
an interface for creating a reference to the second user in a feed.

6. The method of claim 5, wherein the interface for defining a new key result for the executed process comprises receiving a selection of a key result type from a plurality of different key result types.

7. The method of claim 1, further comprising receiving the first event at an event listener that is subscribed to events generated by the first user interface.

8. A non-transitory computer-readable medium comprising instructions that, when executed by one or more processors, cause the one or more processors to perform operations comprising:
receiving, by a computer system, input from a first user at a first user interface in a plurality of user interfaces, wherein the input defines an executed process that is monitored by the computer system during execution;
automatically generating, by the computer system, a first event based on receiving the input through the first user interface;
translating, by the computer system, the first event into one or more actions for one or more users;
aggregating, by the computer system, a plurality of actions for a second user in the one or more users, wherein the plurality of actions comprises:
at least one of the one or more actions translated from the first event; and
a plurality of additional actions translated from events that were automatically generated based on receiving inputs through other user interfaces in the plurality of user interfaces other than the first user interface; and
causing, by the computer system, the plurality of actions for the second user to be displayed in a unified action list comprising actions from a plurality of different sources.

9. The non-transitory computer-readable medium of claim 8, wherein the operations further comprise determining a type of the first event based on a type of the first user interface in the plurality of user interfaces.

10. The non-transitory computer-readable medium of claim 9, wherein translating the first event into one or more actions for one or more users comprises:
identifying the second user as being associated with the executed process;
extracting one or more fields from the event; and
generating a first action using the one or more fields from the event and an identifier for the second user.

11. The non-transitory computer-readable medium of claim 8, wherein the operations further comprise:
accessing a pre-trained model for the first event and the first user;
providing a plurality of fields from the first event to the pre-trained model;
receiving an output from the pre-trained model predicting an outcome of the executed process; and
causing the output from the pre-trained model predicting the outcome of the executed process to be displayed as part of the unified action list.

12. The non-transitory computer-readable medium of claim 8, wherein the plurality of user interfaces comprises:
an interface for defining a new key result for the executed process;
an interface for defining a new objective for the executed process; and
an interface for creating a reference to the second user in a feed.

13. The non-transitory computer-readable medium of claim 12, wherein the interface for defining a new key result for the executed process comprises receiving a selection of a key result type from a plurality of different key result types.

14. The non-transitory computer-readable medium of claim 8, wherein the operations further comprise receiving the first event at an event listener that is subscribed to events generated by the first user interface.

15. A system comprising:
one or more processors; and
one or more memory devices comprising instructions that, when executed by the one or more processors, causes the one or more processors to perform operations comprising:
receiving, by a computer system, input from a first user at a first user interface in a plurality of user interfaces, wherein the input defines an executed process that is monitored by the computer system during execution;
automatically generating, by the computer system, a first event based on receiving the input through the first user interface;
translating, by the computer system, the first event into one or more actions for one or more users;
aggregating, by the computer system, a plurality of actions for a second user in the one or more users, wherein the plurality of actions comprises:
at least one of the one or more actions translated from the first event; and
a plurality of additional actions translated from events that were automatically generated based on receiving inputs through other user interfaces in the plurality of user interfaces other than the first user interface; and
causing, by the computer system, the plurality of actions for the second user to be displayed in a unified action list comprising actions from a plurality of different sources.

16. The system of claim 15, wherein the operations further comprise determining a type of the first event based on a type of the first user interface in the plurality of user interfaces.

17. The system of claim 16, wherein translating the first event into one or more actions for one or more users comprises:
identifying the second user as being associated with the executed process;
extracting one or more fields from the event; and
generating a first action using the one or more fields from the event and an identifier for the second user.

18. The system of claim 15, wherein the operations further comprise:
accessing a pre-trained model for the first event and the first user;
providing a plurality of fields from the first event to the pre-trained model;
receiving an output from the pre-trained model predicting an outcome of the executed process; and
causing the output from the pre-trained model predicting the outcome of the executed process to be displayed as part of the unified action list.

19. The system of claim 15, wherein the plurality of user interfaces comprises:
an interface for defining a new key result for the executed process;
an interface for defining a new objective for the executed process; and
an interface for creating a reference to the second user in a feed.

20. The system of claim 19, wherein the interface for defining a new key result for the executed process comprises receiving a selection of a key result type from a plurality of different key result types.
